(19) United States
(12) Patent Application Publication
(10) Pub. No.: US 2009/0031113 A1
(43) Pub. Date: Jan. 29, 2009

(54) Processor Array, Processor Element Complex, Microinstruction Control Appraratus, and Microinstruction Control Method

(75) Inventor: Shogo Nakaya, Tokyo (JP)

Correspondence Address: FOLEY AND LARDNER LLP;SUITE 500, 3000 K STREET NW, WASHINGTON, DC, 20007, US

(73) Assignee: NEC CORPORATION, Tokyo (JP)

(21) Appl. No.: 11/920,156

(22) PCT Filed: May 9, 2006
(86) PCT No.: PCT/JP2006/309325

§ 371 Date: Nov. 9, 2007

(30) Foreign Application Priority Data
May 12, 2005 (JP) 2005-139258

(51) Int. Cl. G06F 9/32; G06F 9/30

(52) U.S. Cl. 712/208; 712/230; 712/E09.073; 712/E09.016

(57) ABSTRACT

A processor array including area-saving microprogram memories is provided. In the processor array, microprogram memories of a plurality of adjacent processor arrays are shared. Effective data and position information 13 on the effective data are stored in the shared microprogram memory 3, and effective data parts 11.1 to 11.3 including effective data are accommodated with each other in logic blocks 2a and 2b of a plurality of processor elements. The number of necessary microprogram memories is thereby reduced, thus realizing area saving.

### TECHNICAL FIELD

The present invention pertains to a processor array executing a microprogram and particularly pertains to a control method and a control apparatus for the microprogram.

### BACKGROUND ART

Much attention has been paid to a processor array because of capability of realizing a high-rate data processing by parallel processing performed by many processor elements differently from a serial processing performed by a single processor, and various proposals have been made for the processor array so far. A conventional example will be briefly described with reference to FIG. 1. FIG. 1(A) is a circuit diagram showing a general configuration of a processor array, and FIG. 1(B) is a block diagram schematically showing an example of an instruction structure of the conventional processor array.

As shown in FIG. 1(A), Japanese Patent Application Laid-Open No. 2001-312481 (Patent Document 1) discloses a processor array constituted so that many processor elements (PEs) 1 are arranged in a two-dimensional array and programmably connected to one another by programmable wirings 100. As shown in FIG. 1(B), each of the processor elements 1 is constituted by a logic block 2 that includes an arithmetic unit and a switch and a microprogram memory 3′. Functions of the arithmetic unit and the switch of each logic block are decided by an instruction output from the corresponding microprogram memory 3′. Functions of the switch are, for example, to set a connection state between the programmable wirings, to select an input from one of the programmable wirings to the arithmetic unit, and to designate on& programmable wiring as a destination to which a calculation result is output. The microprogram memory 3′ holds therein a plurality of instructions and an address signal 4 generated by a sequencer 200 determines which of the instructions is to be output.

Actually, however, in most cases, a part of the arithmetic unit or a part of the switch within each logic block is controlled simultaneously by an instruction. In other words, only a part of the instructions designated by the address signal 4 are used as implemented instructions, and the remaining instructions wastefully occupy the microprogram memory 3 each as a default (e.g., a logic value 0).

A method for avoiding such wasteful occupation of such instructions in the memory is disclosed in Japanese Patent Application Laid-Open No. 7-175648 (Patent Document 2). The method is featured in that instructions are stored in memory while excluding unused fields (i.e., default parts) of each of the instructions, and in that at the time of reading one instruction, the excluded unused fields are returned into an original state so as to use the instruction as one instruction. Although it is necessary to add information indicating at which positions the respective unused fields are present in an instruction having a predetermined length, memory saving can be realized as a whole (see paragraphs [0013] to [0022] and FIGS. 1 and 2).

Patent Document 1: Japanese Patent Application Laid-Open No. 2001-312481

Patent Document 1: Japanese Patent Application Laid-Open No. 7-175648

### DISCLOSURE OF THE INVENTION

### Problems to be Solved by the Invention

However, the memory saving method described in the Patent Document 2 is executed on the premise of a single processor, so that even if the method is applied to a processor array as it is, memory saving cannot be attained effectively. Differently from the single processor, the processor array includes programmable wirings 100. Due to this, far more switches are provided in the logic blocks of each processor element 1. As a result, the processor array results in far more wasting of the microprogram memory than the single processor, and the memory saving method described in the Patent 2 Document cannot obtain a sufficient memory reduction effect.

### Means for Solving the Problems

The present invention is made to solve the conventional problems. A processor array including an array of a plurality of programmably connected logic blocks, includes a plurality of memory units arranged to correspond to the array of the plurality of logic blocks, and each storing a plurality of effective data parts in at least a part of which effective data of a plurality of microinstructions are stored, respectively, and control information indicating at which positions of each of the microinstructions the effective data parts correspond to, respectively; and microinstruction generating units connecting the plurality of memory units to a plurality of logic blocks to which the plurality of microinstructions is to be supplied, and generating microinstructions deciding functions of the plurality of logic blocks, respectively, from the effective data parts and predetermined data based on the control information.

In other words, the microprogram memories of a plurality of adjacent processor elements in the processor array are shared, the effective data and the positional information on the effective data are stored in each of the microprogram memories, and the logic blocks of a plurality of processor elements accommodate one another with the effective data parts including the effective data.

It is preferable that the plurality of logic blocks is arranged in a two-dimensional array, and that the microinstruction generating units connects each of the plurality of memory units to two vertically adjacent logic blocks.

According to one exemplary embodiment of the present invention, it is preferable that the microinstruction generating units connects each of the plurality of memory units to two adjacent logic blocks, and connects each of the plurality of logic blocks to two adjacent memory units.

A processor element complex according to one exemplary aspect of the present invention includes a plurality of logic blocks programmably connectable to other logic blocks; memory units storing a plurality of encoding instructions each including a plurality of effective data parts in at least a part of which effective data of a plurality of microinstructions are stored, respectively, and control information indicating at which positions of each of the microinstructions the effective data parts correspond to, respectively; an address decoder designating one of the plurality of encoding instructions according to an address signal; and decoding units connecting the memory units to the plurality of logic blocks, and decoding microinstructions deciding functions of the plurality of logic blocks, respectively, from the effective data parts and predetermined data based on the control information on the designated encoding instruction.

As an exemplary embodiment, either the microinstruction generating units or the decoding units includes a plurality of selectors each provided to correspond to each of the logic blocks, each selecting one of the effective data parts and the predetermined data according to the control information, and generating a plurality of interval data including each of the microinstructions.

A processor array according to an exemplary aspect of the present invention includes a plurality of equivalent logic blocks B₁ to B_{N} (where N is an integer 2 or more); a plurality of selector attached to the logic blocks, respectively; and a plurality of microprogram memories P₁ to P_{N-1} arranged to correspond to the logic blocks B₁ to B_{N}, respectively, wherein each of logic blocks B₁ to B_{N} includes an arithmetic unit and a switch programmably connecting the logic blocks to each other, wherein each of a plurality of instructions stored in each of the microprogram memories P₁ to P_{N-1} includes positional information and a plurality of effective data parts, the positional information and the plurality of effective data parts are supplied from a microprogram memory Mᵢ₋₁ (where i=2, . . . , N−1) to a first group among the plurality of selectors attached to an arbitrary logic block Bᵢ, and the positional information and the plurality of effective data parts are supplied from a microprogram memory Mᵢ to a second group among the plurality of selectors, each of the plurality of selectors selects one of the plurality of effective data parts and a specified value to be output as an interval instruction based on data included in the positional information, interval instructions output from the plurality of selectors decide functions of the corresponding logic blocks, respectively, and wherein a total data width of the plurality of effective data parts of the microprogram memories is smaller than a total data width of the interval instructions with respect to each of the logic blocks.

A microinstruction control apparatus according to an exemplary aspect is characterized by a plurality of memory units arranged to correspond to an array of the plurality of logic blocks, and each storing a plurality of effective data parts in at least a part of which effective data of a plurality of microinstructions are stored, respectively, and control information indicating at which positions of each of the microinstructions the effective data parts correspond, respectively; and microinstruction generating units connecting the plurality of memory units to a plurality of logic blocks to which the plurality of microinstructions is to be supplied, respectively, and generating microinstructions deciding functions of the plurality of logic blocks, respectively, from the effective data parts and predetermined data based on the control information.

A microinstruction control method according to an exemplary aspect includes storing a plurality of encoding instructions each including a plurality of effective data parts in at least a part of which effective data of a plurality of microinstructions are stored, respectively, and control information indicating at which positions of each of the microinstructions the effective data parts correspond to, respectively; designating one of the plurality of encoding instructions according to an address signal; decoding microinstructions deciding functions of the plurality of logic blocks from the effective data parts and predetermined data based on the control information on the designated encoding instruction, respectively; and supplying the decoded microinstructions to the corresponding logic blocks, respectively.

### EFFECTS OF THE INVENTION

According to the present invention, microprogram memory is shared among a plurality of processor elements, and the data stored in microprogram memory are based on the effective data. It is, therefore, possible to reduce an area of each microprogram memory and to greatly reduce a memory space in the processor array.

Furthermore, by sharing microprogram memory of the processor elements vertically arranged according to the conventional art, it is possible to adjust the width of each logic block to be equal to that of the conventional processor element or to change the width of each logic block only slightly. It is advantageously possible to dispense with redesigning arrangement of the arithmetic units and switches of the logic elements or to change the arrangement only slightly.

Moreover, each of a plurality of memory units is connected to two adjacent logic blocks and each of a plurality of logic blocks is connected to two adjacent memory units, thereby considerably simplifying circuit configuration and reducing circuit area and delay. Further, since a range of transferring the effective data and the control information is narrowed, it is advantageously possible to make wiring length shorter. Besides, adaptability of the effective data is improved since, for example, a maximum of four effective data can be used per logic block.

### BEST MODE FOR CARRYING OUT THE INVENTION

### 1. First Embodiment

1.1) Processor Array

FIG. 2 is used to describe a processor array according to a first embodiment of the present invention to be compared with a conventional processor array. FIG. 2(A) is a schematic block diagram showing an instruction structure of the processor array according to the first embodiment of the present invention. FIG. 2(B) is a schematic block diagram showing an instruction structure of the conventional processor array. While only processor elements in two rows by four columns are shown for brevity of drawings, processor elements' of a desired number may be arranged.

In FIG. 2(A), a plurality of processor element complexes 300 is arranged in the processor array according to the first embodiment. A sequencer 200 outputs an address signal 4 to each of the processor element complexes 300. As will be described later, each processor element complex 300 includes two logic blocks 2a and 2b and a shared microprogram memory 3 storing therein instructions to the logic blocks 2a and 2b.

The logic blocks 2a and 2b of the processor element complex 300 correspond to two independent processor elements 1a and 1b laterally adjacent to each other according to the conventional art as shown in FIG. 2(B), respectively. Therefore, the logic blocks 2a and 2b are identical circuits.

Further, the shared microprogram memory 3 of the processor element complex 300 is integrate memory of microprogram memory 3a and 3b of the conventional processor elements 1a and 1b. As will be described later, a plurality of compressed instructions is stored in each shared microprogram memory 3, and one compressed instruction is read according to the address signal 4 input from the sequencer 200. The read compressed instruction is decoded to two microinstructions, and the logic blocks 2a and 2b are controlled by the two microinstructions, respectively. Control of the corresponding logic block by each microinstruction is similar to that according to the conventional art.

In this manner, it is possible to reduce an area of the microprogram memory by sharing the microprogram memory among a plurality of processor elements.

1.2) Processor Element Complex

FIG. 3 is a block diagram showing a configuration of the processor element complex according to the first embodiment of the present invention. The processor element complex 300 includes the two logic blocks 2a and 2b, the shared microprogram memory 3 storing therein a plurality of compressed instructions, and a decoding unit generating two microinstructions to be supplied to the respective logic blocks 2a and 2b. As will be described later, the decoding unit comprises selectors 7.1a to 7.4a attached to the logic block 2a, and selectors 7.1ba to 7.4b attached to the logic block 2b.

The shared microprogram memory 3 includes a memory core 30 storing therein an address decoder 5 decoding the address signal 4 and the plural instructions, and outputs one of the plural instructions to the decoding unit according to the address signal 4.

Each microinstructions according to the first embodiment includes four interval instructions, and each interval instruction is generated by one selector. Namely, interval instructions 6.1a to 6.4a generated by the four selectors 7.1a to 7.4a are input as one microinstruction to one logic block 2a, respectively. Interval instructions 6.1b to 6.4b generated by the four selectors 7.1b to 7.4b are input as one microinstruction to the other logic block 2a, respectively.

Furthermore, each of the instructions 10 stored in the shared microprogram memory 3 according to the first embodiment includes three effective data parts 11.1 to 11.3 and positional information (SC) 13 indicating positions of those effective data parts, respectively. As will be described later, selection control data 8.1a to 8.4a and 8.1b to 8.4b each for designating one of the effective data and a default to each selector as the interval instruction are written to the positional information 13.

Data of the effective data part 11.1 included in the shared microprogram memory 3 are output to the selectors 7.1a to 7.4a and the selectors 7.1a to 7.2b, data on the effective data part 11.2 are output to the selectors 7.2a to 7.4a and the selectors 7.1a to 7.3b, and data on the effective data part 11.3 are output to the selectors 7.3a to 7.4a and the selectors 7.1a to 7.4b, respectively. The selectors 7.1a to 7.4a are selection-controlled by the selection control data 8.1a to 8.4a of the positional information 13, respectively. The selectors 7.1b to 7.4b are selection-controlled by the selection control data 8.1b to 8.4b of the positional information 13, respectively. For example, since data are input to the selector 7.4a from the three effective data parts 11.1 to 11.3, the selector 7.4a selects one output from among the three input data and one default according to the selection control data 8.4a.

In FIG. 3, a data width of each of the effective data parts 11.1 to 11.3 is equal to that of each of the interval instructions 6.1a to 6.4a and 6.1b to 6.4b. A data width of instructions necessary for each of the logic blocks 2a and 2b is equal to a sum of data widths of the interval instructions 6.1a to 6.4a (or 6.1b to 6.4b). Therefore, even if all of the three effective data parts 11.1 to 11.3 are allocated to one of the logic blocks, an instruction data width for the logic block is insufficient. In this case, the default is used to compensate for the insufficient data.

As already described, all bits are used as effective information in one microinstruction less frequently. Due to this, in most cases, it suffices to prepare three effective data parts as described in the first embodiment. If it is necessary to use all the bit of an instruction, it is possible to deal with this by executing the instruction while dividing it into a plurality of instructions. In that case, the number of required clocks increases. However, overall performance is hardly changed if such a situation occurs only a few times in the entire program.

1.3) Memory Saving Method

FIG. 4(A) is a pattern diagram showing an example of a plurality of microinstructions stored in the microprogram memory cores 30a and 30b for the independent adjacent processor elements according to the conventional art. FIG. 4(B) is a pattern diagram showing a plurality of compressed instructions stored in the memory core 30 according to the first embodiment of the present invention. FIG. 4(C) is a pattern diagram showing a format of the positional information 13 in one compressed instruction.

In FIG. 4(A), five word data (where one word data corresponds to one microinstruction of the processor element) are stored in each of the microprogram memory cores 30a and 30b in sequence, and white parts indicate effective bits and parts hatched by slashes indicate ineffective bits (defaults). In the first embodiment, word data in each memory core are divided into interval data corresponding to the respective interval instructions described above. FIG. 4(A) shows an example of the four interval data equally divided from one word data.

In the example shown in FIG. 4(A), effective bits are present in leading interval data A and trailing interval data B of the word data (i.e., microinstruction) stored in a first row (i.e., last row in FIG. 4(A)) of the microprogram memory core 30a, respectively, and the other interval data is all ineffective bits. Moreover, all the word data stored in a leading row (i.e., last row in FIG. 4(A)) of the microprogram memory core 30b is ineffective bits. If the effective bits are included in the interval data, the interval data is assumed as “effective data”; otherwise, the interval data is assumed as “ineffective data”. Accordingly, in FIG. 4(A), interval data A to L are effective data.

The word data stored in the microprogram memory cores 30a and 30b of the adjacent processor elements are integrated according to order. As shown in FIG. 4(B), only the effective data A to L are stored together with positional information thereon in the shared microprogram memory 30. In FIG. 4(B), each of the compressed instructions stored in the shared microprogram memory core 30 is consisting of positional information (SC) and three effective data parts 11.1 to 11.3. The effective data parts 11.1 to 11.3 correspond to three interval allocations of the integrated word data in FIG. 4(A), respectively. For example, since effective data A is located on a left end of the integrated word data 10.1, the effective data A is written to the effective data part 11.1, and since effective data B is located on central two columns, the effective data B is written to the effective data part 11.2, respectively.

As can be seen, each of the integrated word data 10.1 to 10.4 shown in FIG. 4(A) has three or less effective data. Due to this, the integrated word data 10.1 to 10.4 are stored to correspond to the compressed instructions 10.1 to 10.4 in the shared microprogram memory 30 shown in FIG. 4(B), respectively. On the other hand, four effective data I, J, K, and L are present in the integrated word data 10.5. In this case, it suffices to store the four effective data I, J, K, and L using the two compressed instructions 10.5 and 106, as shown in FIG. 4(B). Accordingly, the number of required clocks for reading increases, however, such a situation occurs only a few times in the entire program, so that the increased clocks hardly influences the entire program and hardly causes deterioration in performance.

As shown in FIG. 4(C), the positional information 13 stores the selection control data 8.1a to 8.4a for controlling selection operations performed by the selectors 7.1a to 7.4a and 7.1b to 7.4b in sequence, respectively. In case of the example shown in this embodiment, each of the selectors 7.1a and 7.4b selects one of one effective data and the default. Therefore, each of the selection control data 8.1a and 8.4b may be one bit. Since each of the other selectors 7.2a to 7.4a and 7.1b to 7.3b selects one of two or three effective data and the default, each of the selection control data 8.2a to 8.4a and 8.1b to 8.3b need to be two bits.

For example, in the compressed instruction 10.1 shown in FIG. 4(B), the effective data A that is first interval data and the effective data B that is fourth interval data are written to the effective data parts 11.1 and 11.2, respectively, so that the positional information 13 is set as follows. The selection control data 8.1a is one-bit data (e.g., “1”) for selecting the effective data from the effective data part 11.1. Since the selection control data 8.2a and 8.3a are ineffective data, the selection control data 8.2a and 8.3a are two-bit data (e.g., “00”) each for selecting the default, and the selection control data 8.4a is two-bit data (e.g., “10”) for selecting the effective data from the effective data part 11.2. Since the selection control data 8.4a and 8.1b to 8.4b are ineffective data, the selection control data 8.4a and 8.1b to 8.4b are two-bit data (e.g., “00”) each for selecting the default.

1.4) Operation

Operation performed by the processor element complex 300 shown in FIG. 3 will be briefly described while taking an instance in which the compressed instructions shown in FIGS. 4(B) and 4(C) are stored in the shared microprogram memory 30 as an example.

It is assumed that the compressed instruction 10.1 shown in FIG. 4(B) is designated by the address signal 4 and read from the shared program memory 30. In this case, the effective data A stored in the effective data part 11.1 are output to the selectors 7.1a to 7.2b and the effective data B stored in the effective data part 11.2 are output to the selectors 7.2a and 7.3b, respectively. The positional information 13 comprises one-bit selection control data 8.1a for selecting effective data from the effective data part 11.1, two-bit selection control data 8.2a and 8.3a for selecting the default from the effective data part 11.1, two-bit selection control data 8.4a for selecting effective data from the effective data part 11.2, and two-bit selection control data 8.4a and 8.1b to 8.4b for selecting the default from the effective data part 11.2. These selection control data 8.1a to 8.4b are output to the selectors 7.1a to 7.4b, respectively.

Accordingly, the interval instruction 6.1a that is the effective data

A is output from the selector 7.1a to the logic block 2a, the interval instructions 6.2a and 6.3a that are the defaults are output from the selector 7.2a and 7.3a to the logic block 2a, and the internal instruction 6.4a that is the effective data b is output from the selector 7.4a to the logic block 2a. Further, the interval instructions 6.4a and 6.1b to 6.4b that are the defaults are output from the selectors 7.1b to 7.4b to the logic block 2b. In this way, one microinstruction is applied to each of the logic blocks 2a and 2b.

If one clock instruction is divided into a plurality of clocks as in the case of the compressed instructions 10.5 and 10.6 shown in FIG. 4(B), then the compressed instruction 10.5 is read by one clock, as described above, the effective data I is held as the interval instruction 6.1a, the defaults are held as the interval instructions 6.2a, the effective data J and K are held as the interval instructions 6.3a and 6.4a, respectively and the defaults are held as the interval instructions 6.1b to 6.3b in each selector. Furthermore, the compressed instruction 10.6 is read by a next clock, the effective data L is held as the interval instruction 6.4b. These interval instructions 6.1a to 6.4a and 6.1b to 6.4b are output to the logic blocks 2a to 2b, respectively.

The block diagram shown in FIG. 3 is an example of the fastest circuit in which no circuit is present between the positional information 13 and each of the selectors. To insert a decoder between the positional information 13 and each selector and to reduce a bit width of the positional information 13 are easily carried out by a person skilled in the art.

Moreover, as already described, it is necessary to convert a data format of the conventional microprogram memory shown in FIG. 4(A) into a format shown in FIG. 4(B) in advance. Namely, it is necessary that the effective data is extracted out of the conventional microprogram, that the selection control data for designating output positions of the respective effective data is generated, and that those created selection control data are stored in predetermined word data. This conversion processing can be performed by dedicated software. Further, this software may be included in a compiler.

As already described, the processor elements in the processor array include many switches for programmable wirings differently from the single processor. Due to this, a ratio of the effective data used simultaneously in the instruction is far lower than that for the single processor.

1.5) Effects

FIG. 5 is a circuit diagram for describing operation performed by the processor array. As shown in FIG. 5, characteristic phenomena often occur to the processor array differently from the single processor. It is assumed that in a processor element (e.g., 1a) indicated by a white rectangle, effective data occupies most parts of the instruction. Further, it is assumed that in a processor element (e.g., 1b) indicated by a square hatched by slashes, ineffective data (defaults) occupies most part of the instruction.

In this way, many processor elements are hardly used uniformly but the processor elements often differ in the ratio of the effective data in the instruction. Moreover, in the processor array, a distribution pattern of the ratio of the effective data as shown in FIG. 5 changes according to clocks. The conventional microprogram memory saving method based on the single processor cannot deal with such a difference in an effective data amount among the processor elements at all.

According to the first embodiment, by contrast, one microprogram memory is shared between the two processor elements. Due to this, it is possible to greatly save the microprogram memory as compared with the conventional art by positively using the difference in effective data amount among the processor elements. In FIG. 3, for example, if the logic block 2a uses much effective data and the logic block 2b uses only a few effective data, then much effective data can be allocated to the logic block 2a from the shared microprogram memory 3 shared between the two logic blocks, and the two logic blocks can accommodate each other with effective data if it is necessary according to the first embodiment. Therefore, the microprogram memory small as a whole can deal with the process.

Furthermore, according to the first embodiment, the number of address decoders 5 to be used decreases as compared with that according to the conventional art. Therefore, it is possible to further reduce the area.

It is described that the number of effective data is three and the number of interval instructions per logic block is four while referring to the block diagram shown in FIG. 3. However, according to the present invention, these numbers are not limited to them but may be arbitrary numbers. A modification of the first embodiment will be described later.

### 2. Second Embodiment

The manner of sharing one microprogram memory between the two processor elements is not limited to that using the processor elements laterally arranged as described in the first embodiment. As shown in FIG. 2(B), in the processor element complex according to the first embodiment described above, the microprogram memory is shared between the two laterally adjacent processor elements 1a and 1b. Due to this, a width of the microprogram memory 3 of the processor element complex 300 shown in FIG. 2(A) is far smaller than a sum of widths of the microprogram memories 3a and 3b of the processor elements 1a and 1b. This is because ineffective data (defaults) are eliminated and a data width of the microprogram memory is saved with sharing of the two microprogram memories. As a result, as shown in FIG. 2(A), widths of the logic blocks 2a and 2b need to be reduced as compared with the conventional width (FIG. 2(B)), and it is necessary to redesign the arrangement of arithmetic units and switches.

In a processor array according to a second embodiment of the present invention, by contrast, microprogram memories 3a and 3b are shared between vertically arranged processor elements 1a and 1b. It is thereby possible to set the width of each of the logic blocks 2a and 2b of the processor element complex 300 to be equal to that of the conventional processor element or to change it only slightly. It is, therefore, advantageously possible to dispense with redesigning the arrangement of the arithmetic units and the switches or to change the arrangement only slightly.

FIG. 6 is used to compare the processor array according to the second embodiment of the present invention with the conventional processor array. FIG. 6(A) is a schematic block diagram showing an instruction structure of the processor array according to the second embodiment of the present invention. FIG. 6(B) is a schematic block diagram showing an instruction structure of the conventional processor array. Although FIGS. 6(A) and 6(B) only show processor elements in two rows by four columns for brevity of the drawings, the same thing is true for arrangement of processor elements of a desired number.

In FIG. 6(A), in the processor array according to the second embodiment, a plurality of processor element complexes 300 is arranged, and an address signal 4 is output from a sequencer 200 to each of the processor element complexes 300. Each of the processor element complexes 300 includes two logic blocks 2a and 2b vertically arranged, and a shared microprogram memory 3 storing therein instructions with respect to the logic blocks 2a and 2b.

As shown in FIG. 6(B), the logic blocks 2a and 2b of each of the processor element complex 300 correspond to the two independent processor elements 1a and 1b laterally adjacent to each other according to the conventional art, respectively. Therefore, the logic blocks 2a and 2b are identical circuits.

Moreover, the shared microprogram memory 3 of each processor element complex 300 is an integrated memory of the microprogram memories 3a and 3b of the conventional processor elements 1a and 1b. As described above, a plurality of compressed instructions is stored in the shared microprogram memory 3 and one compressed instruction is read according to the address signal 4 input from the sequencer 200. Two microinstructions are decoded from the read compressed instruction and the logic blocks 2a and 2b are controlled by the two microinstructions, respectively. Since a configuration of each of the microprocessor element complexes 300 is similar to that shown in FIG. 3, it will not be described herein.

### 3. Third Embodiment

The number of processor elements sharing one microprogram memory is not limited to two as described in the first and second embodiments.

FIG. 7 is used to compare a processor array according to a third embodiment of the present invention with the conventional processor array. FIG. 7(A) is a schematic block diagram showing an instruction structure of the processor array according to the third embodiment of the present invention. FIG. 7(B) is a schematic block diagram showing an instruction structure of the conventional processor array. Although FIGS. 7(A) and 7(B) only show processor elements in two rows by four columns for brevity of the drawings, the same thing is true for arrangement of processor elements of a desired number.

In FIG. 7(A), in the processor array according to the third embodiment, a plurality of processor element complexes 300 is arranged, and an address signal 4 is output from a sequencer 200 to each of the processor element complexes 300. Each of the processor element complexes 300 includes two logic blocks 2a and 2b vertically arranged, and a shared microprogram memory 3 storing therein instructions with respect to the logic blocks 2a and 2b.

As shown in FIG. 7(B), the logic blocks 2a, 2b, 2c, and 2d of each of the processor element complexes 300 correspond to the four independent processor elements 1a, 1b, 1c, and 1d vertically and laterally adjacent to one another according to the conventional art, respectively. Therefore, the logic blocks 2a, 2b, 2c, and 2d are identical circuits.

Moreover, the shared microprogram memory 3 of each processor element complex 300 is an integrated memory of the microprogram memories 3a, 3b, 3c, and 3d of the conventional processor elements 1a, 1b, 1c, and 1d. As described above, a plurality of compressed instructions is stored in the shared microprogram memory 3 and one compressed instruction is read according to the address signal 4 input from the sequencer 200. Two microinstructions are decoded from the read compressed instruction and the logic blocks 2a, 2b, 2c, and 2d are controlled by the two microinstructions, respectively.

A configuration of each of the microprocessor element complexes 300 according to the third embodiment is basically similar to that shown in FIG. 3 except that the number of control target logic blocks increases. Namely, the logic blocks 2c and 2d are added to the logic blocks 2a and 2b shown in FIG. 3, and selectors are similarly added to correspond to the logic blocks 2c and 2d. As described above, each of instructions 10 stored in the memory core 30 includes positional information 13 in which selection control data corresponding to interval instructions with respect to the respective logic blocks is arranged, and a plurality of effective data parts. The respective effective data parts are connected so that selectors as output destinations at predetermined numbers shift sequentially. This connection relationship is merely expansion of the connection relationship between the memory core 30 and the respective selectors shown in FIG. 3.

### 4. Fourth Embodiment

According to the present invention, it is possible to not only control a plurality of logic blocks using one microprogram memory but also control one logic block using a plurality of microprogram memories.

FIG. 8 is a schematic block diagram showing an instruction structure of a processor array according to a fourth embodiment of the present invention. While FIG. 8 shows the processor array in which processor elements are arranged in the form of lines for brevity of the drawing, the same thing is true for the processor array in which a desired number of processor elements may be arranged in the form of area.

In FIG. 8, in the processor array according to the fourth embodiment, a plurality of logic blocks 2i and a plurality of shared microprogram memories 3ij are arranged in parallel in the form of lines, one shared microprogram memory controls two logic blocks, and one logic block is controlled by the two shared microprogram memories. If i is replaced by a, b, c or d and j is replaced by b, c or d according to the symbols shown in FIG. 8, then one shared microprogram memory 3ab controls two nearest logic blocks 2a and 2b, and one logic block 2b is controlled by two nearest shared microprogram memories 3ab and 3bc.

Namely, one microprogram memory 3ij distributes effective data to logic blocks 2i and 2j. An arrow 9 extending from one microprogram memory to two logic blocks shown in FIG. 8 indicates to which logic blocks each of the microprogram memories distributes effective data. Accordingly, effective data are distributed to each logic block 2j from two microprogram memories 3ij and 3jk.

FIG. 9 is a block diagram showing a detailed configuration of the processor array shown in FIG. 8. In FIG. 9, the same reference numerals are used to denote the same blocks as those shown in FIG. 8, and block configuration and operation described in FIG. 3 will not be described. For brevity of description, while a configuration related to a shared microprogram memory 3bc and logic blocks 2b and 2c is also described, the same thing is true for the other shared microprogram memories and logic blocks.

It is assumed first in the fourth embodiment that each instruction 10 stored in each shared microprogram memory 3 includes two effective data parts 11.1 and 11.2 and one positional information 13. The effective data parts and the positional information are similar to those described with reference to FIGS. 4(B) and 4(C). Further, it is assumed that each of logic blocks other than a leading logic block and a trailing logic block receives interval instructions 6.1 to 6.4 from four selectors 7.1 to 7.4, the leading logic block receives interval instructions 6.3 and 6.4 from two selectors 7.3 and 7.4, and the trailing logic block receives interval instructions 6.1 and 6.2 from selectors 7.1 and 7.2, respectively. It is to be noted that the number of effective data and that of interval instructions shown herein are only an example and the number of effective data and that of interval instructions are not limited to those shown in FIG. 9.

Referring to selectors 7.1b to 7.4b supplying interval instructions to the logic block 2b shown in FIG. 9, a left half of them, i.e., the selectors 7.1b and 7.2b receive effective data from the shared microprogram memory 3ab, and a right half of them, i.e., the selectors 7.3b and 7.4b receive effective data from the shared microprogram memory 3bc.

Referring to the shared microprogram memory 3bc, data of an effective data part 11.1bc are output to selectors 7.3b, 7.4b, and 7.1c, respectively, and data of an effective data part 11.2bc are output to selectors 7.4b, 7.1c, and 7.2c, respectively. The selectors 7.3b, 7.4b, 7.1c, and 7.2c are selection-controlled by selection control data 8.3b, 8.4b, 8.1c, and 8.2c of positional information 13bc, respectively. For example, effective data are input to the selector 7.4b from two effective data parts 11.bc and 11.2bc. Due to this, the selector 7.4b selects one output from among two input data and one default according to the selection control data 8.4b.

Therefore, according to the fourth embodiment, it suffice to select one output from among up to three (i.e., two effective data and one default). It is thereby possible to greatly simplify circuit configuration and to reduce circuit area and delay.

Moreover, since a range of transferring the effective data and the selection control data is narrowed (i.e., the number of connected selectors per effective data decreases), it is advantageously possible to make wiring length shorter. Besides, adaptability of the effective data is improved since, for example, up to four effective data can be used per logic block. In this way, according to the fourth embodiment, it is possible to save the microprogram memories while ensuring further area saving area and higher rate.

In the configuration shown in FIG. 9, each of the shared microprogram memories includes two effective data parts from which effective data are distributed to two logic blocks, respectively. Therefore, each logic block includes two effective data in average. Namely, half of the four interval instructions held by one logic block are effective data in average.

### 5. Modification

In the first and second embodiments of the present invention, it has been described that the number of effective data of the instructions stored in each shared microprogram memory is three and that the number of interval instructions per logic block is four. However, the present invention is not limited to these numbers. A modification will now be described.

FIG. 10 is a schematic block diagram showing an instruction structure of a processor array according to a modification of the first or second embodiment of the present invention. FIG. 11 is a block diagram showing a detailed configuration of each processor element complex. In FIGS. 10 and 11, the same constituent elements are used to denote the same blocks, and block configuration and operation described in FIG. 3 will not be described. While the processor array in which processor elements are arranged in the form of lines is shown for brevity of the drawing, the same thing is true for the processor array in which a desired number of processor elements may be arranged in the form of area.

According to the modification, each logic block receives effective data only from one shared microprogram memory. Each of instructions 10 stored in each shared microprogram memory 3 according to the modification includes four effective data parts 11.1 to 11.4 and positional information (SC) 13 indicating positions of the respective effective data parts. As already described, selection control data 8.1a to 8.4a and 8.1b to 8.4b each for designating one of the effective data or a default to each selector as an interval instruction are written to the positional information 13.

Data of the effective data part 11.1 included in each shared microprogram memory 3 are output to the selectors 7.1a to 7.4a and 7.1a, respectively. Data of the effective data part 11.2 are output to the selectors 7.2a to 7.4a and 7.1a to 7.2b, data of the effective data part 11.3 are output to the selectors 7.3a to 7.4a and 7.1a to 7.3b, and Data of the effective data part 11.4 are output to the selectors 7.4a and 7.1a to 7.4b, respectively. The selectors 7.1a to 7.4a are selection-controlled by the selection control data 8.1a to 8.4a of the position information 13, respectively. For example, since data are input to the selector 7.4a from the four effective data parts 11.1 to 11.4, respectively, the selector 7.4a selects one output from among the four input data and one default according to the selection control data 8.4a.

In FIG. 11, a data width of each of the effective data parts 11.1 to 11.4 is equal to that of each of the interval instructions 6.1a to 6.4a and 6.1b to 6.4b. A data width of instructions necessary for each of the logic blocks 2a and 2b is equal to a sum of data widths of the interval instructions 6.1a to 6.4a (or 6.1b to 6.4b). Therefore, by allocating all of the four effective data parts 11.1 to 11.4 to one of the logic blocks, one microinstruction can be comprised.

In this manner, the four effective data 11.1 to 11.4 are distributed to the two logic blocks 2a and 2b. Therefore, half of the four interval instructions per one logic block are effective data in average. According to the modification, therefore, an average effective data amount per logic block is equal to that according to the fourth embodiment shown in FIG. 4.

### INDUSTRIAL APPLICABILITY

The present invention is applicable to a processor array in which a plurality of processor elements is arranged in a one-dimensional or two-dimensional array.

### BRIEF DESCRIPTION OF THE DRAWINGS

FIG. 1(A) is a circuit diagram showing an ordinary configuration of a processor array, and FIG. 1(B) is a block diagram schematically showing an example of an instruction structure of a conventional processor array.

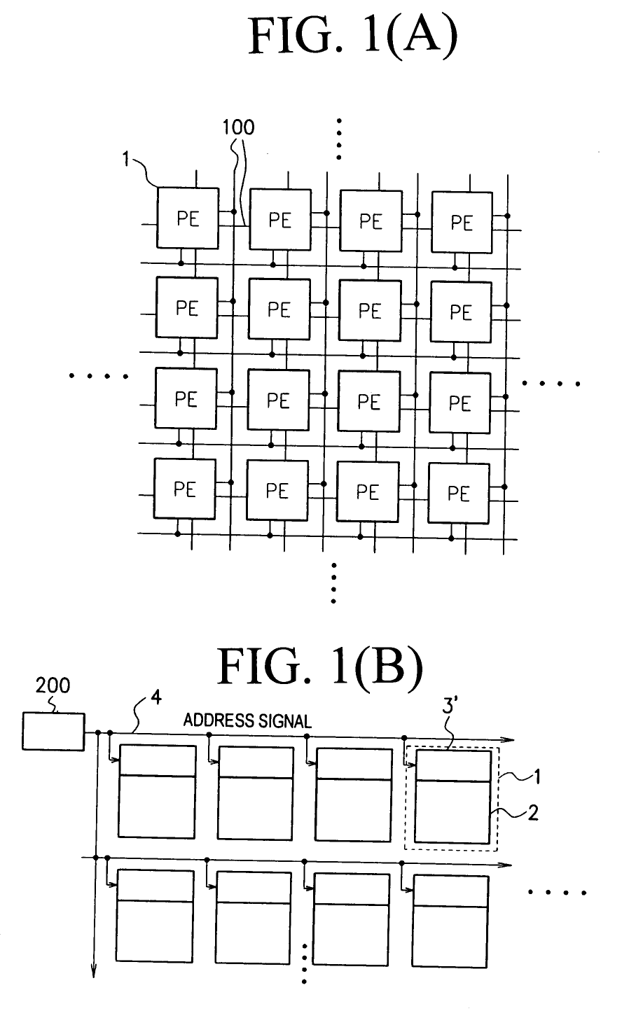

FIG. 2(A) is a schematic block diagram showing an instruction structure of a processor array according to a first embodiment of the present invention, and FIG. 2(B) is a schematic block diagram showing an instruction structure of a conventional processor array.

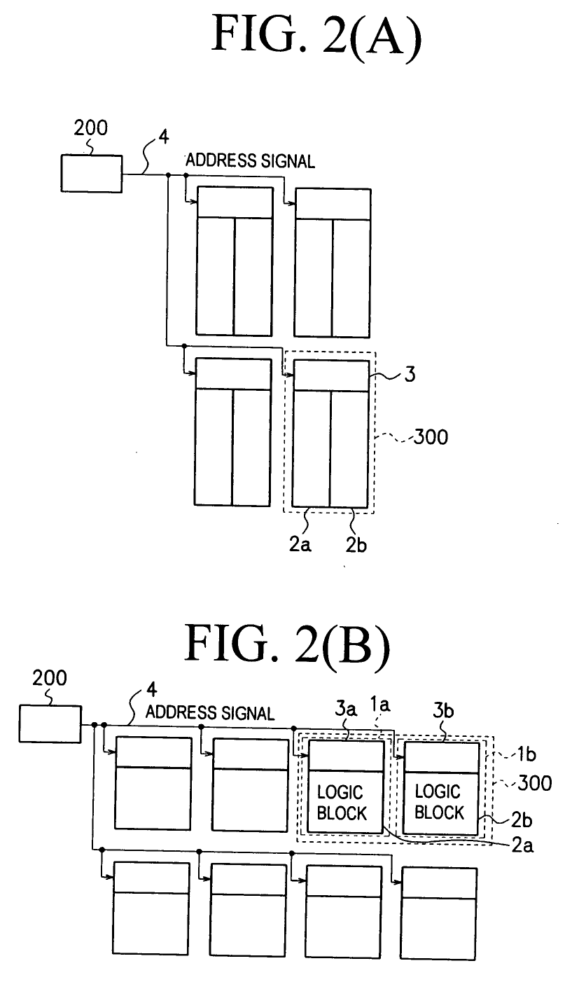

FIG. 3 is a block diagram showing a configuration of a processor array element complex according to the first embodiment of the present invention.

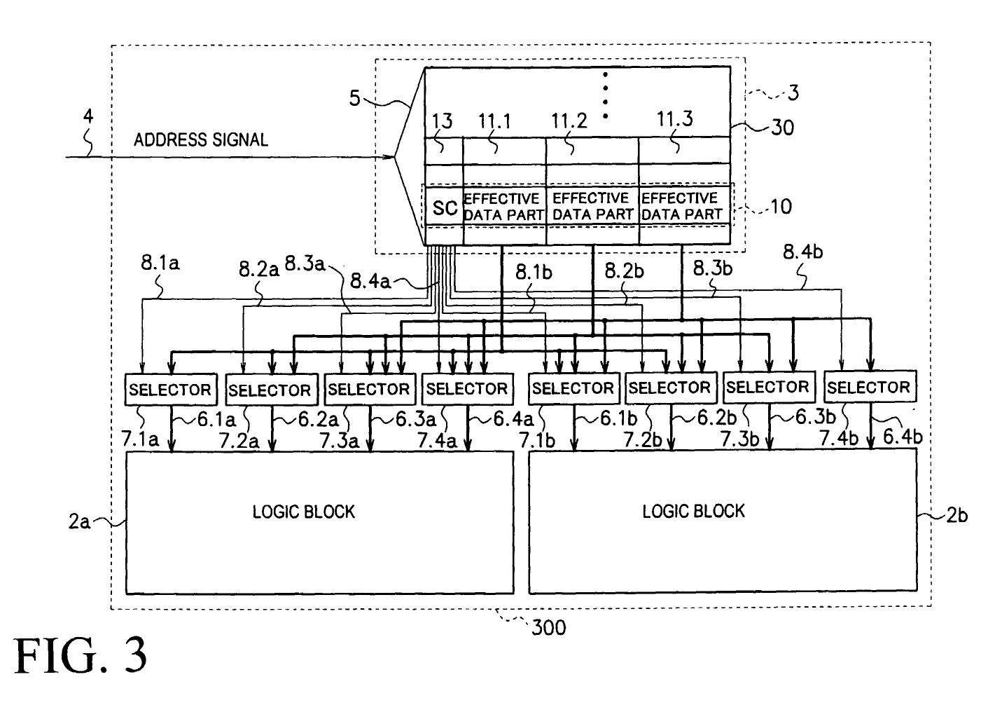

FIG. 4(A) is a pattern diagram showing an example of a plurality of microinstructions stored in microprogram memory cores 30a and 30b of conventional independent processor elements adjacent to each other, FIG. 4(B) is a pattern diagram showing a plurality of compressed instructions stored in a memory core 30 according to the first embodiment of the present invention and FIG. 4(c) is a pattern diagram showing a format of the positional information 13 in one compressed instruction.

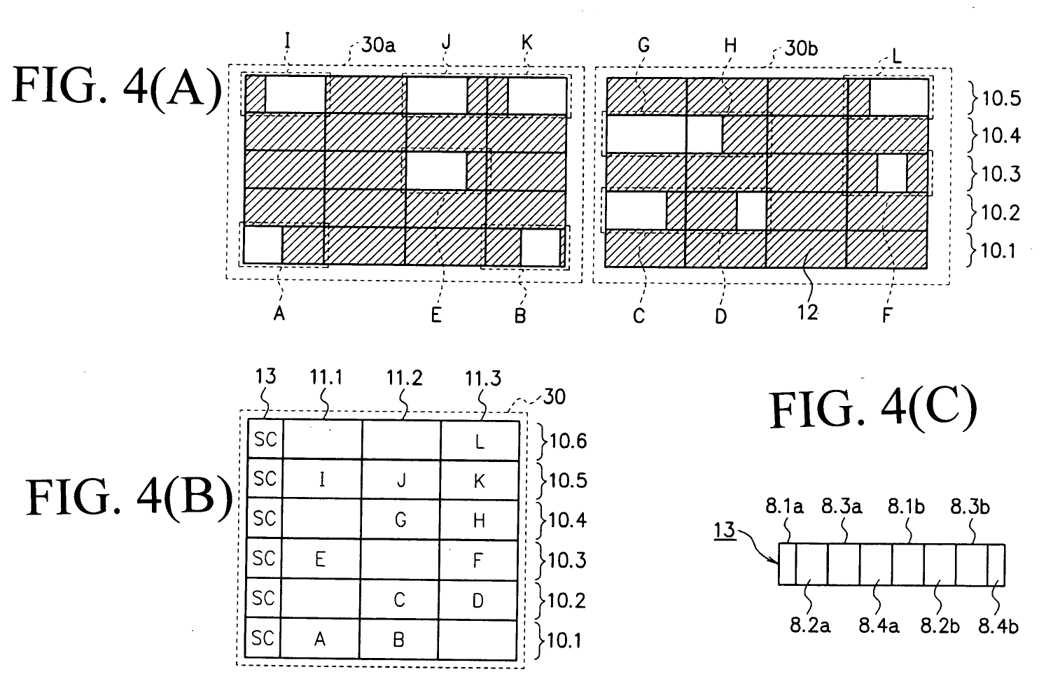

FIG. 5 is a circuit diagram for explaining operation performed by a processor array.

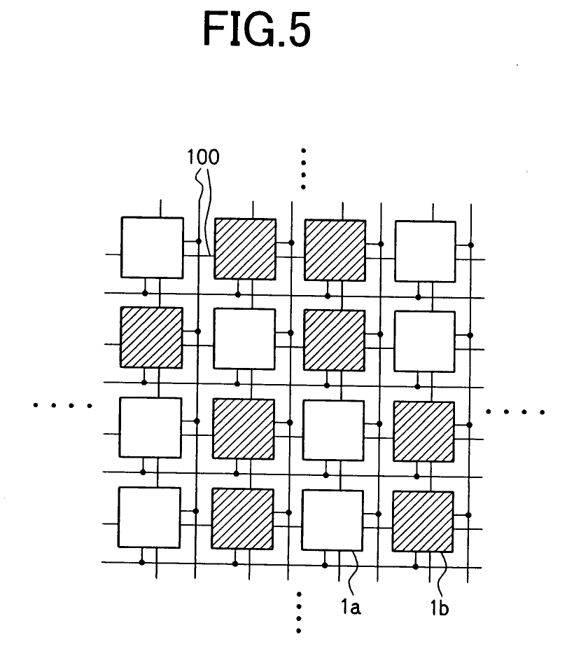

FIG. 6(A) is a schematic block diagram showing an instruction structure of a processor array according to a second embodiment of the present invention, and FIG. 6(B) is a schematic block diagram showing an instruction structure of the conventional processor array.

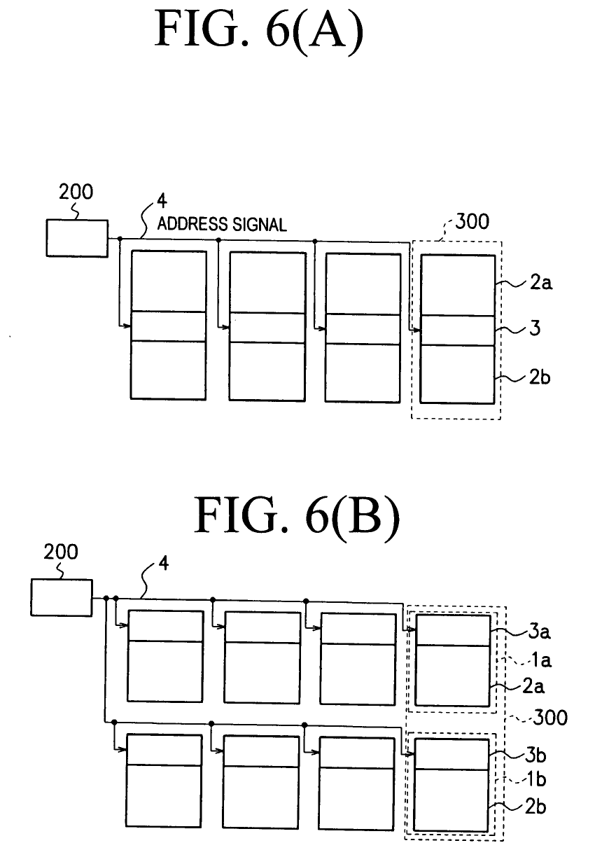

FIG. 7(A) is a schematic block diagram showing an instruction structure of a processor array according to a third embodiment of the present invention, and FIG. 7(B) is a schematic block diagram showing an instruction structure of the conventional processor array.

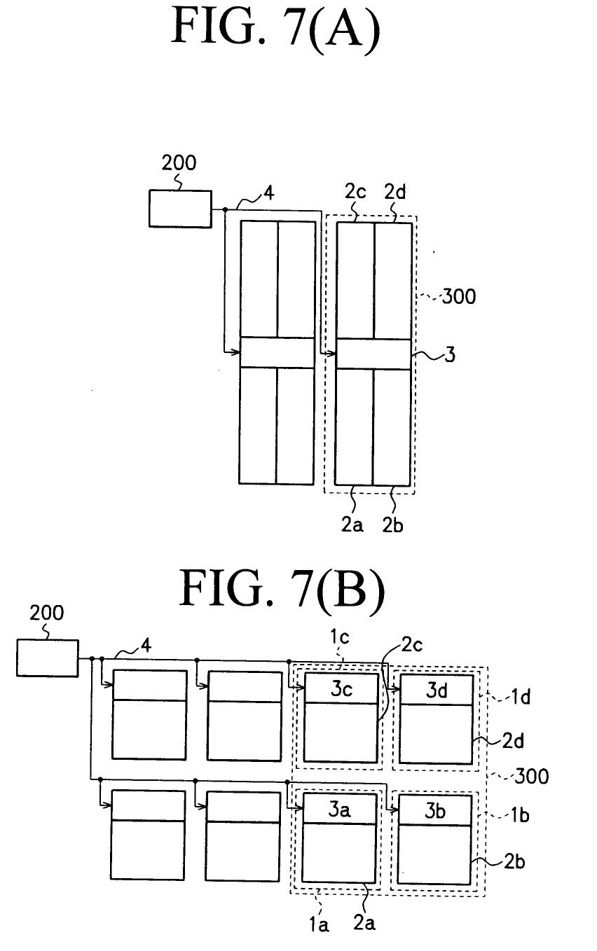

FIG. 8 is a schematic block diagram showing an instruction structure of a processor array according to a fourth embodiment of the present invention.

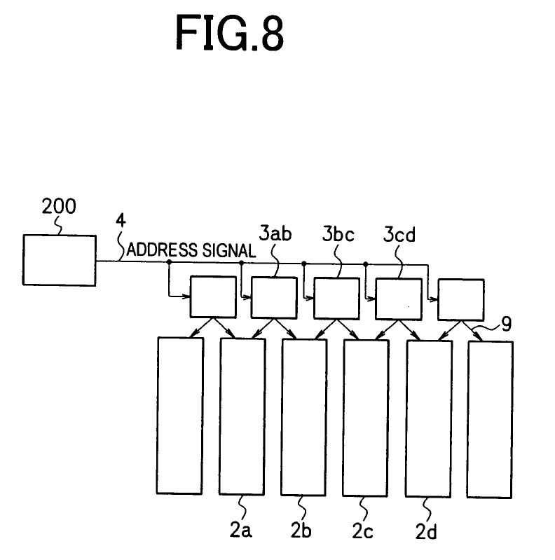

FIG. 9 is a block diagram showing a detailed configuration of the processor array shown in FIG. 8.

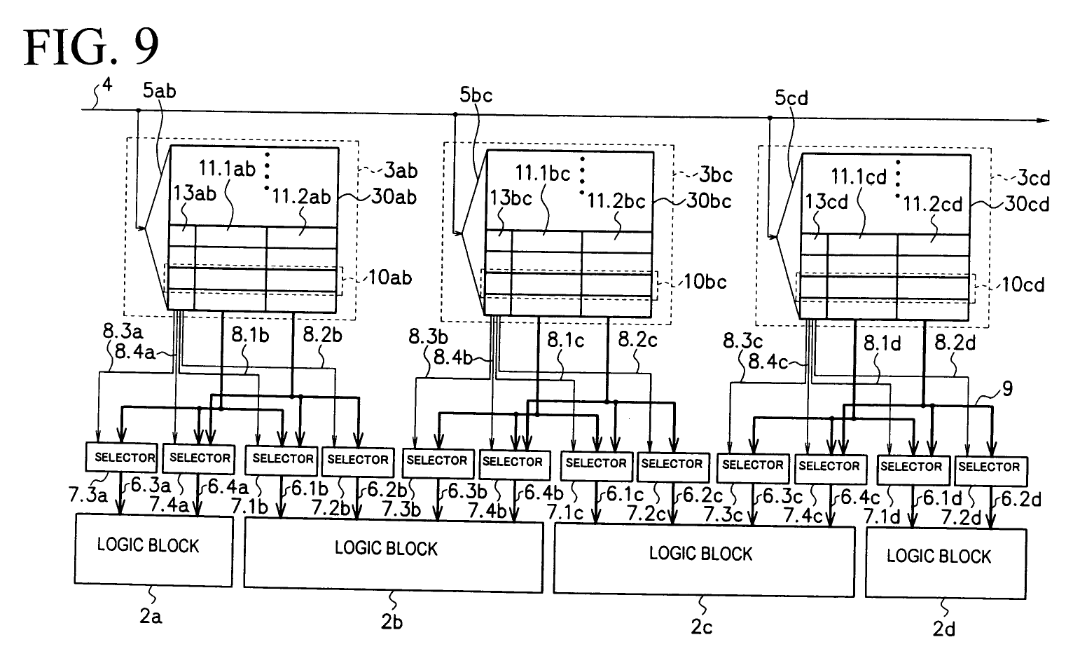

FIG. 10 is a schematic block diagram showing an instruction structure of a processor array according to a modification of the first or second embodiment of the present invention.

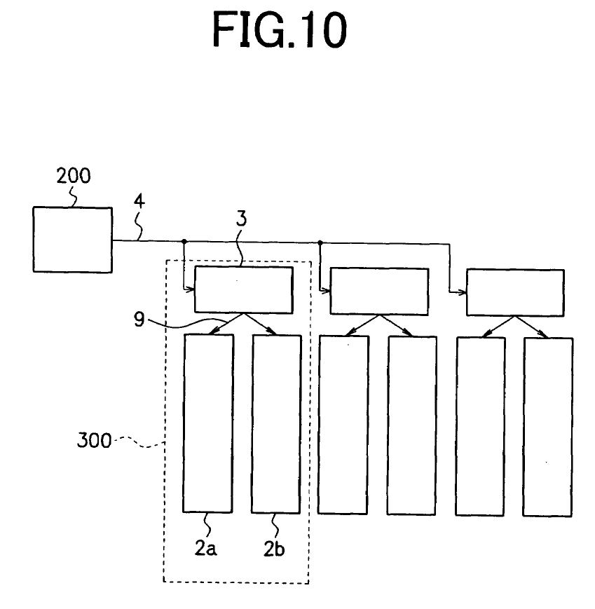

FIG. 11 is a block diagram showing a detailed configuration of a processor element complex shown in FIG. 10.

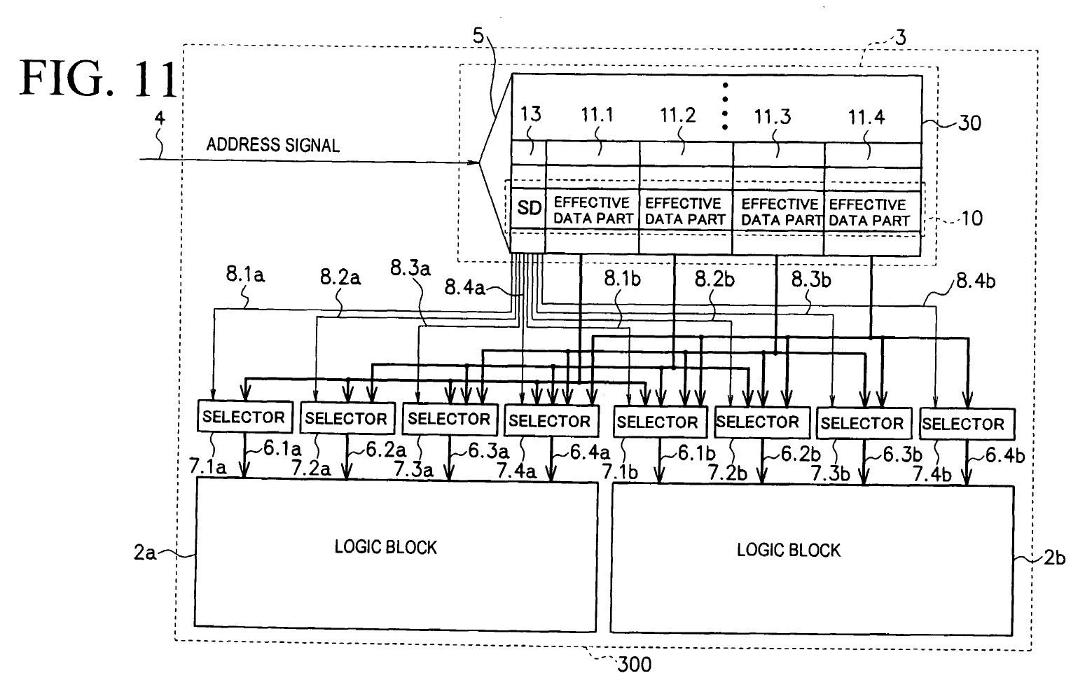

### DESCRIPTION OF REFERENCE NUMERALS

1, 1a, 1b processor element
2, 2a, 2b logic block
3, 3a, 3ab, 3bc, 3cd microprogram memory
4 address signal of microprogram memory
5, 5ab, 5bc, 5cd address decoder
6.1a to 6.4a, 6.1b to 6.4b, 6.1c to 6.4c, 6.1d to 6.2d interval instruction
7.1a to 7.4a, 7.1b to 7.4b, 7.1c to 7.4c, 7.1d to 7.2d selector
8.1a to 8.4a, 8.1b to 8.4b, 8.1c to 8.4c, 8.1d to 8.2d selection control data in positional information
9 distribution range of effective data
10, 10ab, 10bc, 10cd instruction
10.1 to 10.6 word data
11.1 to 11.4, 11.1ab, 11.2ab, 11.1bc, 11.2bc, 11.1cd, 11.2cd effective data part
12 default
13, 13ab, 13bc, 13cd positional information
30, 30ab, 30bc, 30cd microprogram memory core
100 programmable wiring
200 sequencer
300 processor element complex

1. A processor array including an array of a plurality of programmably connected logic blocks, comprising:
a plurality of memory units arranged to correspond to the array of the plurality of logic blocks, and each storing a plurality of effective data parts in at least a part of which effective data of a plurality of microinstructions are stored, respectively, and control information indicating at which positions of each of the microinstructions the effective data parts correspond to, respectively; and
microinstruction generating units connecting the plurality of memory units to a plurality of logic blocks to which the plurality of microinstructions is to be supplied, and generating microinstructions deciding functions of the plurality of logic blocks, respectively, from the effective data parts and predetermined data based on the control information.

2. The processor array according to claim 1,
wherein the plurality of logic blocks is arranged in a one-dimensional array, and the microinstruction generating units connects each of the plurality of memory units to two adjacent logic blocks.

3. The processor array according to claim 1,
wherein the plurality of logic blocks is arranged in a two-dimensional array, and the microinstruction generating units connects each of the plurality of memory units to two vertically adjacent logic blocks.

4. The processor array according to claim 1,
wherein the plurality of logic blocks is arranged in a two-dimensional array, and the microinstruction generating units connects each of the plurality of memory units to four vertically and laterally adjacent logic blocks.

5. The processor array according to claim 1,
wherein the plurality of logic blocks is arranged in a one-dimensional array, and the microinstruction generating units connects each of the plurality of memory units to two adjacent logic blocks, and connects each of the plurality of logic blocks to two adjacent memory units.

6. The processor array according to claim 1,
wherein the plurality of logic blocks is arranged in a two-dimensional array, and the microinstruction generating units connects each of the plurality of memory units to two adjacent logic blocks, and connects each of the plurality of logic blocks to two adjacent memory units.

7. The processor array according to claim 1,
wherein the microinstruction generating units includes a plurality of selecting units each provided to correspond to each of the logic blocks, each selecting one of the effective data parts and the predetermined data according to the control information and each generates a plurality of interval data including each of the microinstructions.

8. The processor array according to claim 1,
wherein a total data width of the plurality of effective data parts stored in the respective plurality of memory units is smaller than a data width of the microinstructions.

9. The processor array according to claim 1,
wherein each of the plurality of memory units further includes an address decoder storing a plurality of instructions each including the plurality of effective data parts and the control information, and designating one of the plurality of instructions according to an address signal.

10. The processor array according to claim 9, further comprising a sequencer generating the address signal.

11. A processor element complex comprising:
a plurality of logic blocks programmably connectable to other logic blocks;
memory units storing a plurality of encoding instructions each including a plurality of effective data parts in at least a part of which effective data of a plurality of microinstructions are stored, respectively, and control information indicating at which positions of each of the microinstructions the effective data parts correspond to, respectively;
an address decoder designating one of the plurality of encoding instructions according to an address signal; and
decoding units connecting the memory units to the plurality of logic blocks, and decoding microinstructions deciding functions of the plurality of logic blocks, respectively, from the effective data parts and predetermined data based on the control information on the designated encoding instruction.

12. The processor element complex according to claim 11,
wherein the decoding units includes a plurality of selectors each provided to correspond to each of the logic blocks, each selecting one of the effective data parts and the predetermined data according to the control information, and generating a plurality of interval data including each of the microinstructions.

13. A processor array in which a plurality of processor element complexes according to claim 11 is arranged, and each of the plurality of logic blocks of each of the processor element complexes includes an arithmetic unit and a switch programmably connecting the logic blocks to each other.

14. A processor array comprising:
a plurality of equivalent logic blocks B₁ to B_{N} (where N is an integer 2 or more); a plurality of selector attached to the logic blocks, respectively; and a plurality of microprogram memories P₁ to P_{N-1} arranged to correspond to the logic blocks B₁ to B_{N}, respectively,
wherein each of logic blocks B₁ to B_{N} includes an arithmetic unit and a switch programmably connecting the logic blocks to each other,
wherein each of a plurality of instructions stored in each of the microprogram memories P₁ to P_{N-1} includes positional information and a plurality of effective data parts,
the positional information and the plurality of effective data parts are supplied from a the microprogram memory Mᵢ₋₁ (where i=2, . . . , N−1) to a first group among the plurality of selectors attached to an arbitrary logic block Bᵢ, and the positional information and the plurality of effective data parts are supplied from a microprogram memory Mᵢ to a second group among the plurality of selectors,
each of the plurality of selectors selects one of the plurality of effective data parts and a specified value to be output as an interval instruction based on data included in the positional information,
interval instructions output from the plurality of selectors decide functions of the corresponding logic blocks, respectively, and
a total data width of the plurality of effective data parts of the microprogram memories is smaller than a total data width of the interval instructions with respect to each of the logic blocks.

15. A microinstruction control apparatus for supplying microinstructions to a plurality of logic blocks, respectively, comprising:
a plurality of memory units arranged to correspond to an array of the plurality of logic blocks, and each storing a plurality of effective data parts in at least a part of which effective data of a plurality of microinstructions are stored, respectively, and control information indicating at which positions of each of the microinstructions the effective data parts correspond to, respectively; and
microinstruction generating units connecting the plurality of memory units to a plurality of logic blocks to which the plurality of microinstructions is to be supplied, respectively, and generating microinstructions deciding functions of the plurality of logic blocks, respectively, from the effective data parts and predetermined data based on the control information.

16. A microinstruction control method for supplying microinstructions to a plurality of logic blocks, respectively, comprising:
storing a plurality of encoding instructions each including a plurality of effective data parts in at least a part of which effective data of a plurality of microinstructions are stored, respectively, and control information indicating at which positions of each of the microinstructions the effective data parts correspond to, respectively;
designating one of the plurality of encoding instructions according to an address signal;
decoding microinstructions deciding functions of the plurality of logic blocks from the effective data parts and predetermined data based on the control information on the designated encoding instruction, respectively; and
supplying the decoded microinstructions to the corresponding logic blocks, respectively.
